(19) United States
(12) Patent Application Publication
(10) Pub. No.: US 2003/0042196 A1
(43) Pub. Date: Mar. 6, 2003

(54) Filter element

(76) Inventors: Hans Leibold, Malsch-Waldprechtsweier (DE); Jorg Kramer, Stutensee (DE); Ingo Mollner, Hockenheim (DE)

Correspondence Address: KLAUS J. BACH & ASSOCIATES, PATENTS AND TRADEMARKS, 4407 TWIN OAKS LANE, MURRYSVILLE, PA, 15668, US

(21) Appl. No.: 10/280,823

(22) Filed: Oct. 25, 2002

Related U.S. Application Data
(63) Continuation-in-part of application No. PCT/EP01/05442, filed on May 12, 2001.

(30) Foreign Application Priority Data
May 20, 2000 (DE) 100 25 141.2

(51) Int. Cl. B01D 27/06

(52) U.S. Cl. 210/493.1; 210/506

(57) ABSTRACT

In a filter element comprising a pleated pack of planar porous filter material sheets with pleat backs, which are reinforced by impregnation or coating with a casting resin or another self-hardening plastic material, the filter element includes transition areas between the impregnated or coated and the non-impregnated or non-coated filter areas wherein the hardened state of the filter material gradually changes to the non-hardened state thereby to reduce chances of fatigue fractures between the hardened and the non-hardened filter areas.

This is a Continuation-In-Part application of international application PCT/EP01/05442 filed May 12, 2001 and claiming the priority of German application 100 25 141.2 filed May 20, 2000.

### BACKGROUND OF THE INVENTION

The present invention resides in a filter element, which can be sealingly inserted into a filter housing and comprises a pleated pack of filter material.

DE 196 01 978 C2 discloses a filter element which can be sealingly inserted into a filter housing. The filter element consists of a highly porous fleece-like filter material, which is pleated accordion style to form a filter pack with a relatively large active filter surface. The pleat backs at the downstream side are connected over their full length to a support mask with slot-like openings arranged in such a way that the slot-like openings are always disposed in the spaces between the pleats. For cleaning, air under pressure is conducted through the filter element in a counter-flow direction. The air is supplied by a cleaning nozzle, which is movable along the downstream side of the filter element to blow air successively into the space between the adjacent pleats for the removal of particles collected on the filter element. The pleat backs are sealed to the support mask to prevent the cleaning air from entering adjacent pleat spaces in order to increase the efficiency of the cleaning process. However, the arrangement as described in DE 196 01 978 C2 requires tight tolerances in the manufacture of the filter pack since different heights of the pleat backs would result in displacements of the filter surfaces and improper inclinations of the filter surfaces and, consequently, in a reduction of the filter efficiency or in increased manufacturing outlays.

It is the object of the present invention to provide a filter element in such a way that, on one hand, the necessary manufacturing accuracy during pleating of the filter elements and their attachment to the slotted support element are tolerable and, on the other hand, the filter element stability and the life of the filter element are increased.

### SUMMARY OF THE INVENTION

In a filter element comprising a pleated pack of planar porous filter material sheets with pleat backs, which are reinforced by impregnation or coating with a casting resin or another self-hardening plastic material, the filter element includes transition areas between the impregnated or coated and the non-impregnated or non-coated filter areas wherein the hardened state of the filter material gradually changes to the non-hardened state thereby to reduce chances of fatigue fractures between the hardened and the non-hardened filter areas.

With the direct casting or other application of reaction resins or self-hardening plastic material structure to the pleat backs of the filter elements which structure extends over the whole flow cross-section at the inlet or outlet side of the filter element, the pleat back area is substantially strengthened so that a separate slotted mask cemented to the pleat backs is superfluous. Furthermore, by the use of casting resin or self-hardening castable plastic with a particular viscosity depending on the intended application of the filter element, the material transition between impregnated, that is, hardened, and non-impregnated, that is, soft fleece-like filter material can individually be adjusted to be abrupt or to be spread over a certain range. The chances of fatigue cracks in the filter material in the transition area can be reduced by providing for a larger transition area.

Another advantage is that the pleat backs can be formed individually. For example, pleat backs can be made to be rounded, that is, streamlined or, they could be provided with corners, which may be advantageous for certain installation conditions. The individual forming of the pleat backs can be achieved either by a corresponding bending of the filter material or by casting the impregnating material into a negative mold of the desired geometry in which also the pleat backs are disposed.

The invention will be described below in greater detail on the basis of two embodiments.

### BRIEF DESCRIPTION OF THE DRAWINGS

FIG. 1 shows a filter element in the shape of a square in a schematic perspective view, and

FIG. 2 shows a filter element with filter panels having spacer webs formed directly onto the filter panels.

### DESCRIPTION OF THE PREFERRED EMBODIMENTS

In both embodiments shown, the filter elements are formed as squares and consist of a filter pack 1 having pleat backs 2 and filter surface areas 3 extending between two opposite end plates 4. The end plates 4 are disposed at the end faces of the pleated filter material pack and extend normal to the filter plates to which they are sealingly connected. The filter pack comprises a highly porous fleece consisting of glass or cellulose, mineral and/or synthetic fibers. The fleece is pleated at the pleat backs twice so that the pleat back includes a planar surface area for installation into a filter housing.

The end plates 4 are pre-fabricated components, which are sealingly cemented onto the end faces of the filter pack. Alternatively, the end plates may consist of casting resins or self-hardening castable plastic materials, which are cast into corresponding negative molds into which also the pleat backs of the filter pack are placed. In this way, the material transition from the end plate or respectively, the impregnated filter material to the non-impregnated filter surfaces can be selected by way of the viscosity of the reaction casting resin or the self-hardening castable plastic material so as to provide a transition area near the pleat backs individually as described earlier.

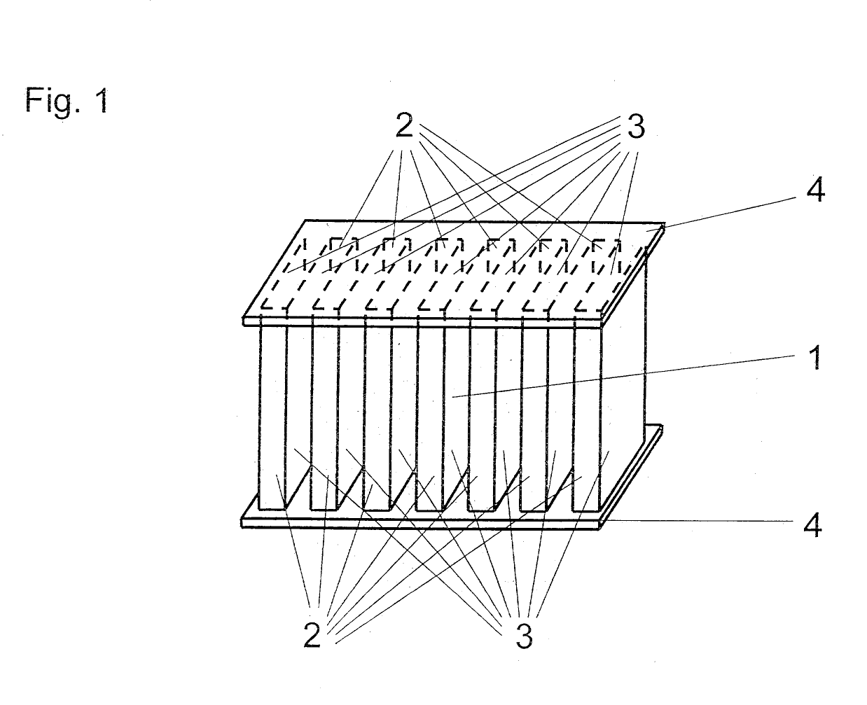

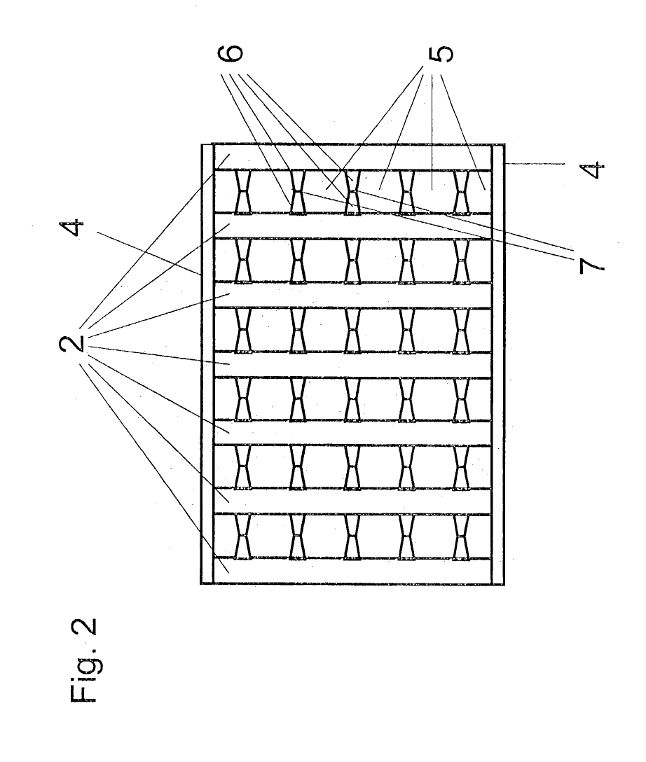

The filter pack however may also have an annular or tubular or cylindrical shape. If, in those shapes, the flow direction through the filter is parallel to the rotational symmetric filter axis, the end plate is tubular in accordance with the cylindrical configuration of the end faces of the filter pack. With a cylindrical shape of the filter pack, the pleat backs extend in two planes radially with respect to the rotational symmetrical filter axis and are joined there sealingly by cementing or by an impregnation procedure. With a radial fluid flow through filter elements with annular or tubular geometry, the front end faces of the filter pack are planar and extend in a plane normal to the rotation symmetric filter axis. FIG. 2 shows the second embodiment wherein the filter areas between two downstream pleat backs 2 are divided into several segments 5. This is the only feature distinguishing this embodiment from that shown in FIG. 1. The segmenting members 6 are webs which are pressed out of the filter material and extend in a direction normal to the pleat backs so that, after the pleating of the filter fleece to form the pleated filter pack, two webs are disposed opposite each-other and are sealingly joined. For the interconnection 7 of the webs 6, cement connections are suitable. Alternatively, the webs may be joined by a casting procedure or by impregnation for example with the casting resin or the self-hardening castable plastic material used for the treatment of the pleat backs.

If the segmenting extends up to the pleat backs 2, the segment dividing webs 6 can be impregnated at their ends together with the pleat back areas 2 with casting resin or self-hardening castable plastic material and formed in a corresponding negative mold.

The web structures 6 impressed into the filter material are also suitable as reinforcement ribs or for increasing the active filter surface area if the area between the filter panels is not to be segmented. In this case, however, it is not necessary to cement two opposite web structures together.

A further reinforcement of the filter element can be achieved by a direct application or casting of casting resins or self-hardening castable plastic also on the upstream side pleat backs of the filter element over the whole surface area width of the filter element. Since then, on one hand, the active filter surface is reduced and on the other hand, the number of transitions between impregnated and non-impregnated filter material, that is areas subject to fatigue cracks, is increased, such an arrangement is reasonable only for special situations.

What is claimed is:

1. A filter element which can be sealingly inserted into a filter housing, comprising: a pleated pack of a planar porous filter material, having pleat backs which are reinforced by impregnation or coating with a casting resin or other self hardening castable plastic material, whose viscosity is selectable depending on desired effects, said filter element including transition areas between the impregnated or coated and the non-impregnated or non-coated areas in which the hardened state of the filter material gradually changes to a non-hardened state so as to reduce chances of fatigue fractures between the hardened and the non-hardened filter areas.

2. A filter element according to claim 1, wherein said filter pleat backs are impregnated with casting resins or a self-hardening castable plastic only at the downstream side thereof so that they are hardened only at said downstream side.

3. A filter element according to claim 1, wherein said pleat backs of said filter elements are hardened by being impregnated in position in a mold into which also the casting resin or the castable plastic material is introduced.

4. A filter element according to claim 3, wherein the resin or plastic disposed on the pleat backs of said filter elements is provided with slots so as to form a slotted mask.

5. A filter element according to claim 1, wherein said filter material is provided with imprinted structures extending normally from the surfaces of the filter elements and forming reinforcement webs.

6. A filter element according to claim 5, wherein said impressed web forming structures are so arranged, that in a pleated state of the filter material in which parallel filter sheets are formed, the webs of opposite filter sheets abut one another and are joined so that the area between two adjacent filter sheets is divided into several filter segments.

7. A filter element according to claim 1, wherein said filter element has one of square, tubular, and annular shape and end plates are sealingly connected to the front ends of the filter pack and extend normal to the pleat backs of the filter elements.

8. A filter element according to claim 1, wherein said filter element has one of a square tubular, annular and cylindrical shape with a cylinder axis and the flow direction for a fluid passing through the filter element is parallel to the cylinder axis, and a tubular end plate is disposed along the front end faces of the filter element pack to which the front end faces are sealingly connected and the pleat backs and the pleated filter element surfaces are sealingly interconnected at the cylinder axis.

9. A filter element according to claim 8, wherein said end plate is sealingly cemented to the end faces of the filter element pack.

10. A filter element according to claim 8, wherein said tubular endplate is formed by a casting resin or a castable plastic disposed in a negative form in which the filter element end faces are disposed in contact with the resin or plastic.
